(19) United States
(12) Patent Application Publication
(10) Pub. No.: US 2023/0405961 A1
(43) Pub. Date: Dec. 21, 2023

(54) APPARATUS FOR ASSEMBLING SEPARATORS AND RELATED PROCEDURE

(71) Applicant: Gabriele BONUCCI, Castel di Casio (BO) (IT)

(72) Inventor: Gabriele BONUCCI, Castel di Casio (BO) (IT)

(21) Appl. No.: 18/027,717

(22) PCT Filed: Oct. 27, 2021
(86) PCT No.: PCT/IT2021/050353

§ 371 Date: Mar. 22, 2023

(30) Foreign Application Priority Data
Oct. 27, 2020 (IT) 102020000025417

(51) Int. Cl. B31D 5/00

(52) U.S. Cl. CPC B31D 5/0026; B31B 2120/25; B31D 5/0013

(57) ABSTRACT

An apparatus for assembling separators includes at least one horizontal destacker for longitudinal die-cut cardboard sheets, capable of delivering the longitudinal sheets at a constant pitch, a conveyor on which the longitudinal sheets advance horizontally, and at least one lateral destacker for transversal die-cut cardboard sheets, capable of delivering the transversal sheets inclined relative to the longitudinal sheets and of positioning them so as to be intercepted by the longitudinal sheets.

### TECHNICAL FIELD

The invention relates to an apparatus for assembling separators, or dividers, and the related procedure.

In the sector for packaging and for transportation of an enormous quantity of products, precautions must often be taken against possible impacts which may affect goods along the path from the manufacturer to the end user.

In various cases, such as, for example, for transportation of pharmaceutical or cosmetics products, of glass products, of products intended for the engines sector, of bottled beverages such as wines and spirits, many pieces are contained in a single outer case, often formed by a plastic or corrugated cardboard large box: in these situations, it is essential that the even inside the case there are separators which cushion impacts of the products against each other in such a way as to keep them safe.

Due to their shape formed by a plurality of adjacent cells, these separators are called “hives”: for a long time, “hives” were made of corrugated cardboard, but in recent decades there has been widespread use of multi-cell “hives” made of solid cardboard.

The simplest “hives” consist of two cardboard sheets appropriately die-cut in such a way that they can be joined to each other to form four cells for containing the products to be transported and kept substantially perpendicular to each other, except for clearances which allow a predetermined mobility for the products.

“Hives” with a greater number of cells are obtained by increasing the number of die-cut cardboard sheets to be joined to each other: for example, two transversal sheets joined to one longitudinal sheet form a “hive” having six cells, whilst three transversal sheets joined to two longitudinal sheets form a “hive” having twelve cells.

### BACKGROUND ART

Even now, most “hive” manufacturers use automated machines provided with a conveyor belt on which the solid cardboard die-cut longitudinal sheets advance, held in the vertical position by very thin guides. The longitudinal sheets then pass below a magazine of transversal sheets, die-cut in a complementary way, in which one or more appropriately synchronised pushers expel the transversal sheets towards the longitudinal sheets, making their respective slots simultaneously coincide.

Continuing to advance along the belt, the “hive” formed encounters an obstacle which flattens it in such a way as to optimise its packaging and transportation.

These machines have an output which allows assembly of approximately 2,500 “hives” per hour: that is due to the fact that the belt cannot exceed a predetermined speed without running the risk of the machine jamming, either because of the difficulty keeping the longitudinal sheets in the vertical position, in particular when they are taller than 20/25 centimetres, or preventing the respective slots from failing to join with each other correctly.

Moreover, the pusher for the transversal sheets must act on regular surfaces and the upper die-cutting often necessitates sub-optimal positioning of the pushers.

Document FR 2571023 also illustrates an automated machine in which use is made of two opposite destackers for die-cut pieces of cardboard, one of which is provided with a suction cup for folding the cardboard into a “U” shape so that the slots in it are opposite the slots of the cardboard delivered from the other destacker.

In this way, when the latter destacker delivers a piece of cardboard, the two pieces of cardboard penetrate each other at the slots forming a separator having six cells, one of which is completely closed by the lower wall of the “U”.

The main limits of this device consist of the fact that it is limited to separators having six cells, being unable to adapt to a smaller or larger number of cells.

Moreover, the “U”-shaped wall does not favour storage of the separators laid flat, in fact the above-mentioned document is intended for direct insertion of the separator into a box, followed by folding of the walls of the box and, consequently, also the separator.

An alternative to use of this type of machines is manual assembly.

It goes without saying that the above-mentioned disadvantages are overcome, but an operator making “hives”, for example having six cells, cannot make 1,500 pieces per hour.

### DISCLOSURE OF THE INVENTION

The aim of this invention is therefore to eliminate the above-mentioned disadvantages.

The invention, as characterised in the claims, achieves the aim thanks to laterally joining the transversal sheets which are inclined relative to the longitudinal sheets, while the latter advance in a horizontal position.

The main advantage obtained by means of this invention basically consists of the fact that there is a considerable increase in production efficiency, since approximately 8,000 “hives” per hour can easily be made. Moreover, since the transversal sheets are joined one at a time to the longitudinal sheets, the causes of jamming are drastically reduced and the shape of the die-cutting becomes completely arbitrary.

Finally, there is no limit on the number of cells, since this can be increased by increasing the number of destackers.

### BRIEF DESCRIPTION OF THE DRAWINGS

Further advantages and features of the invention will be more apparent in the detailed description which follows, with reference to the accompanying drawings, which show an example, non-limiting embodiment, in which:

FIG. 1 illustrates the invention according to a perspective assembly view;

FIG. 1a illustrates the invention according a perspective view during its operation;

FIG. 1b illustrates a detail of FIG. 1a;

FIG. 2 illustrates the process for assembling the separators;

FIGS. 3 and 4 illustrate details of the invention;

FIG. 4a illustrates a detail of FIG. 4, with some parts cut away to better illustrate others;

FIGS. 5 to 7 illustrate accessory devices installed on the detail of FIG. 4;

FIGS. 8a and 8b illustrate a crucial step of the process for assembling the separators.

### PREFERRED EMBODIMENTS OF THE INVENTION

As can be seen from the figures, the invention relates to an apparatus for assembling separators, or dividers, defined “hives”, made of solid or, at most, micro-corrugated cardboard, with thickness not greater than 2 millimetres.

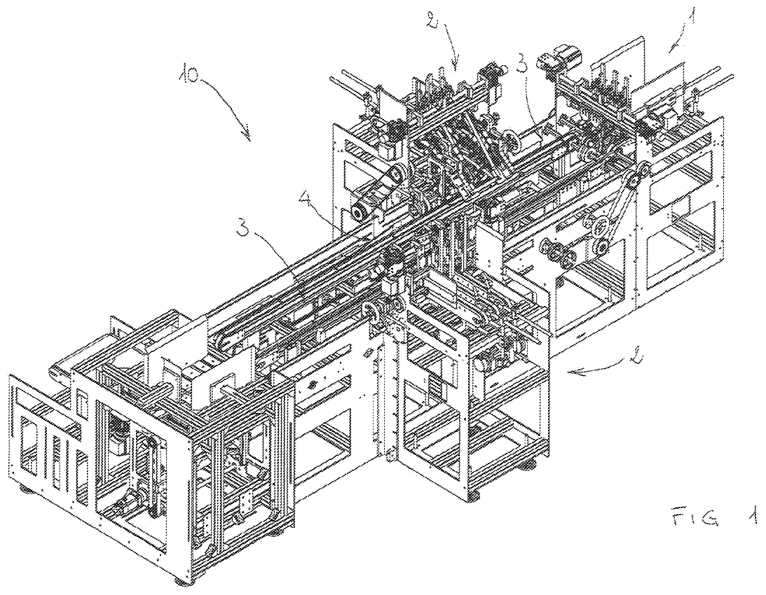

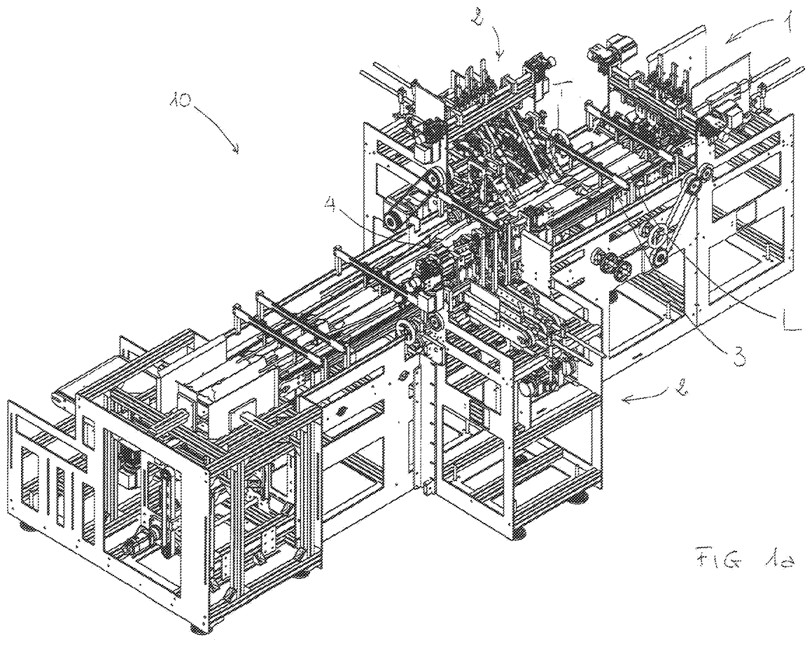

The apparatus (10), whose basic parts are shown in FIG. 1, comprises at least one horizontal destacker (1) for longitudinal die-cut cardboard sheets (L), capable of delivering the longitudinal sheets (L) at a constant pitch, a conveyor (3) on which the longitudinal sheets (L) advance horizontally, and at least one lateral destacker (2) for transversal die-cut cardboard sheets (T), capable of delivering the transversal sheets (T) inclined at an angle (α) of less than 90°, and preferably less than 45°, relative to the conveyor (3), and therefore relative to the longitudinal sheets (L), and of positioning them so as to be intercepted by the longitudinal sheets (L); located downstream of the lateral destacker (2) there being a device for rotating (4) the transversal sheets (T), capable of overlapping them on to the longitudinal sheets (L), so as to form a separator (20), or “hive”, already flattened and ready for storage. In FIG. 1a, the apparatus (10) is shown in an operating step: in this example embodiment, in the enlarged detail of FIG. 1b, it can be seen how the rotation device (4) comprises at least one inclined guide (41).

Since the longitudinal sheets (L) and the transversal sheets (T) intercept each other at only one slot at a time for each of them, it follows that in order to make a separator (20) having four cells only one lateral destacker (2) will be necessary, for a separator having six cells two will be necessary, for a separator having eight cells three will be necessary, and so on.

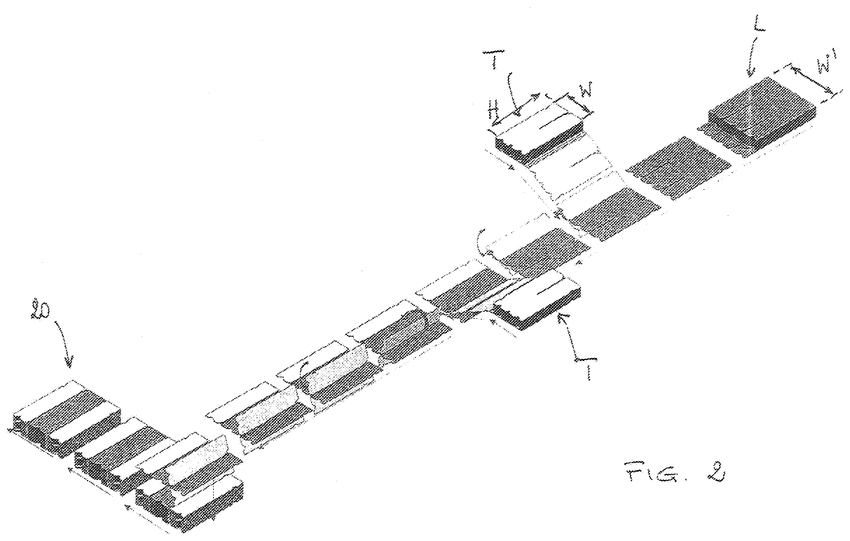

As can be seen in FIG. 3, the conveyor (3) comprises at least one pair of belts (31), capable of supporting and keeping horizontal the longitudinal sheets (L) coming out of the horizontal destacker (1).

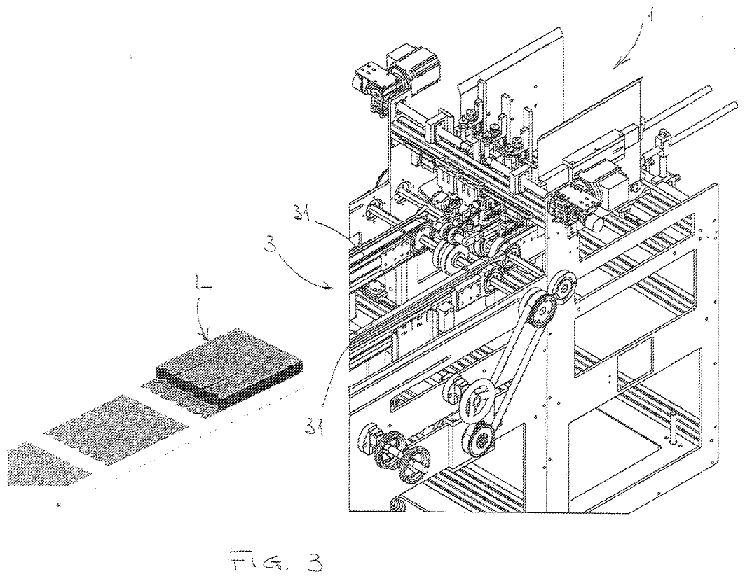

Each lateral destacker (2), illustrated as whole in FIG. 4, comprises a pair of unloading devices (21), more clearly visible in FIG. 4a, capable of carrying and releasing the transversal sheets (T); each unloading device (21) comprises a lower belt (21a) and an upper belt (21b), between which the transversal sheets (T) advance inclined relative to the longitudinal sheets (L).

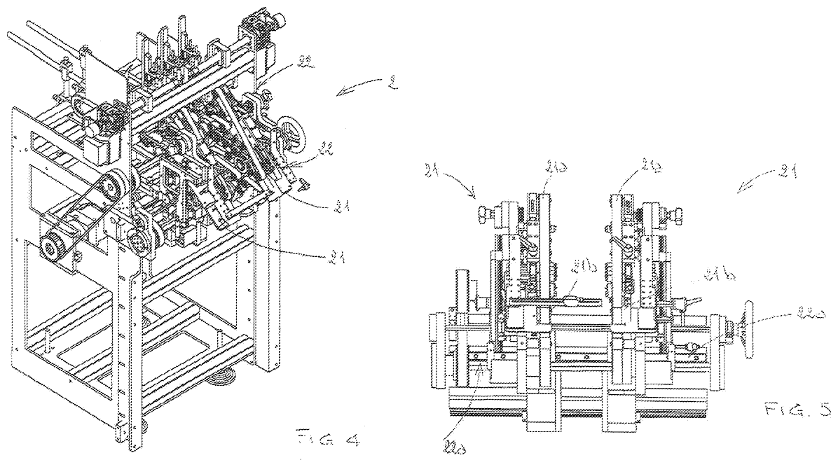

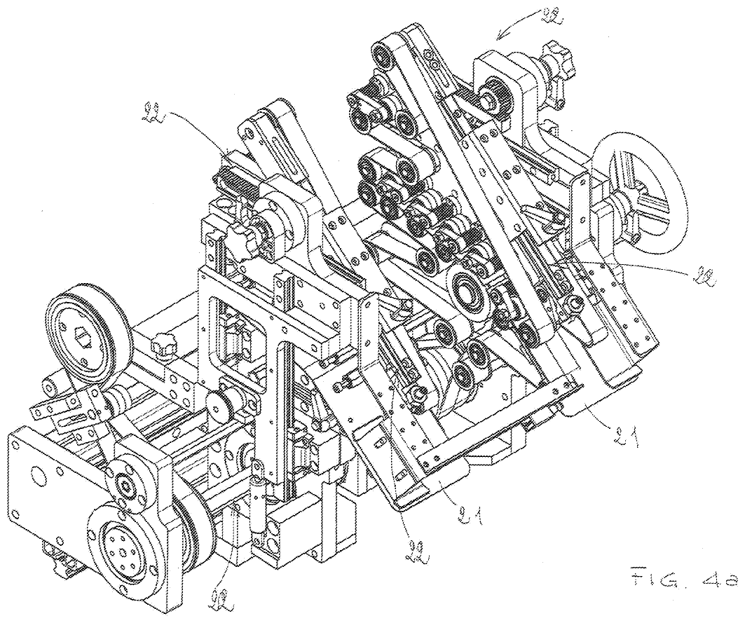

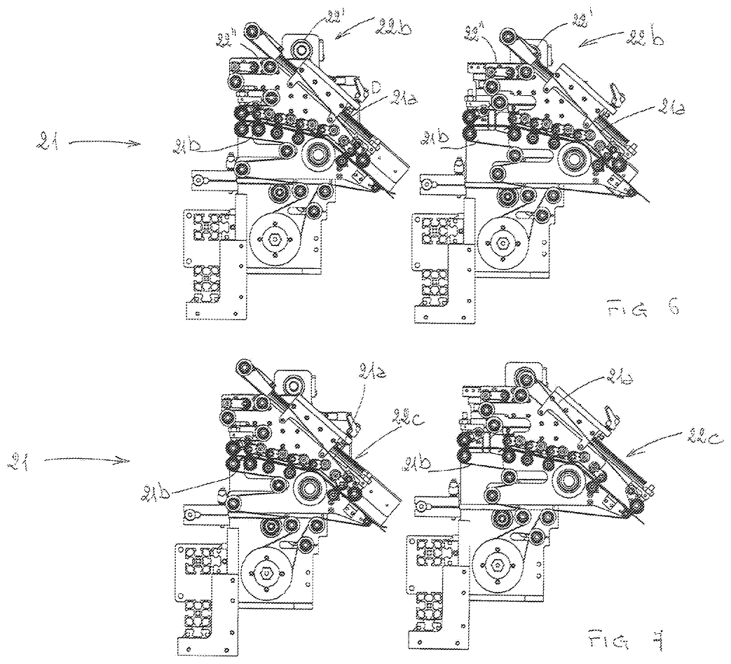

The lateral destacker (2) also comprises a set of adjustment devices (22) for the unloading devices (21), capable of adapting their positioning, and therefore operation, to the dimensions of the transversal sheets (T) and of the longitudinal sheets (L), shown in FIGS. 5 to 7: visible in FIG. 5 are sliding guides (22a), which allow the distance between the unloading devices (21) to be modified, so as to adapt the position of the unloading devices to the height (H) of the transversal sheets (T); FIG. 6 shows means for advancing (22b) the unloading devices (21), here formed for example by a complementary toothed wheel (22′) and rack (22″), capable of adapting the position of the unloading devices to the width (W′) of the longitudinal sheets (L); FIG. 7 shows means for sliding (22c) the upper belt (21b) and a lower movable stop (22d), capable of adapting the position of the upper belt and of the stop to the width (W) of the transversal sheets (T).

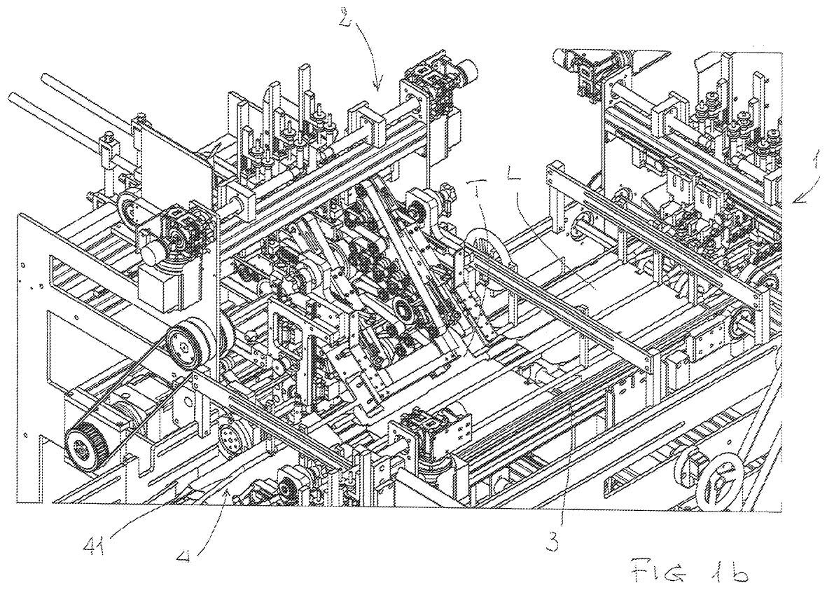

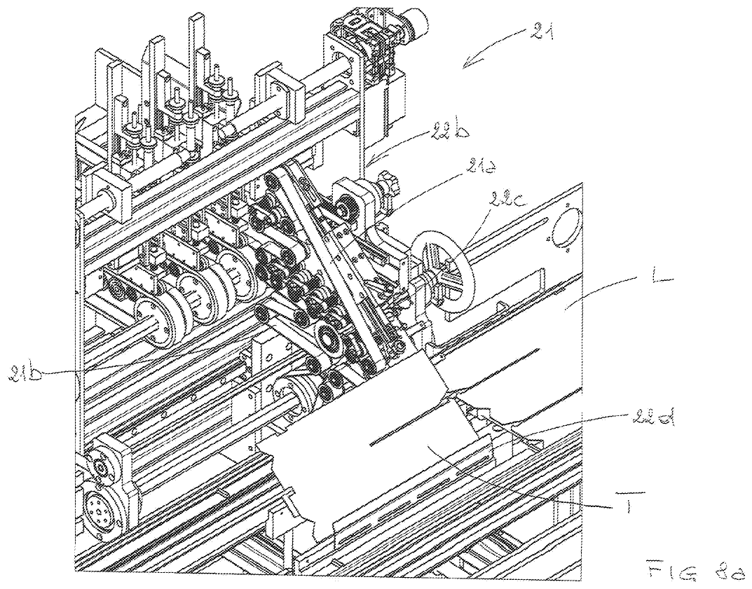

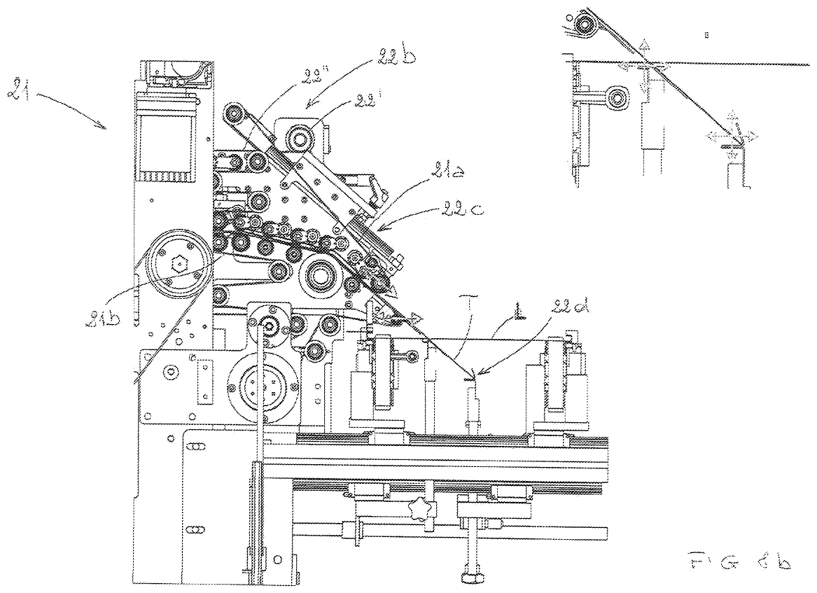

FIG. 2 shows the process for assembling a separator (20) having six cells, for which the presence of two lateral destackers (2) is necessary. Therefore it comprises at least the following steps: a horizontal destacker (1) inserts longitudinal die-cut cardboard sheets (L) in a horizontal position at a constant pitch onto a conveyor (3); each lateral destacker (2) delivers a transversal sheet (T) of die-cut cardboard inclined relative to the conveyor (3), and therefore relative to the longitudinal sheet (L), at an angle (α) of less than 90°, and preferably less than 45°, so that a single slot of each transversal sheet (T) aligns with a slot of the longitudinal sheet (L) which is arriving; the longitudinal sheet (L) intercepts the transversal sheets (T) (this step, crucial for the entire procedure, is shown in FIGS. 8a and 8b); the transversal sheets (T) are turned over onto the longitudinal sheet (L) so as to overlap each other; the flattened separators (20) are stacked.

1. Apparatus for assembling separators, comprising at least one horizontal destacker for longitudinal die-cut cardboard sheets, capable of delivering the longitudinal sheets at a constant pitch, and a conveyor on which the longitudinal sheets advance horizontally, characterised in that wherein it comprises at least one lateral destacker for transversal die-cut cardboard sheets, capable of delivering the transversal sheets inclined relative to the longitudinal sheets at an angle of less than 90°, and of positioning them so as to be intercepted by the longitudinal sheets.

2. Apparatus according to claim 1, wherein the angle is less than 45°.

3. Apparatus according to claim 1, wherein it comprises a device for rotating the transversal sheets, capable of overlapping them on to the longitudinal sheets.

4. Apparatus according to claim 1, characterised in that wherein the lateral destacker comprises a pair of unloading devices, capable of carrying and releasing the transversal sheets.

5. Apparatus according to claim 3, characterised in that wherein each unloading device comprises a lower belt and an upper belt, between which the transversal sheets advance inclined relative to the longitudinal sheets.

6. Apparatus according to claim 3, wherein the lateral destacker comprises adjustment devices for the unloading devices, capable of adapting their operation to the dimensions of the transversal sheets and of the longitudinal sheets.

7. Apparatus according to claim 5, wherein the adjustment devices comprise sliding guides, which allow the distance between the unloading devices to be modified, so as to adapt the position of the unloading devices to the height of the transversal sheets.

8. Apparatus according to claim 5, wherein the adjustment devices comprise means for advancing the unloading devices, so as to adapt the position of the unloading devices to the width of the longitudinal sheets.

9. Apparatus according to claim 5, wherein the adjustment devices comprise means for sliding the upper belt and a movable stop so as to adapt the position of the upper belt and of the stop to the width of the transversal sheets.

10. Apparatus according to claim 1, wherein the conveyor comprises at least one pair of belts, capable of supporting the longitudinal sheets.

11. Apparatus according to claim 2, wherein the rotation device comprises at least one inclined guide.

12. Apparatus according to claim 7, wherein the advancement means comprise a complementary toothed wheel and rack.

13. Procedure for assembling separators, wherein it comprises the following steps:
longitudinal die-cut cardboard sheets are horizontally inserted onto a conveyor at a constant pitch;
at least one transversal die-cut cardboard sheet is delivered along the path of the conveyor inclined relative to the conveyor at an angle of less than 90°, and preferably less than 45°, so that a single slot of a transversal sheet aligns with a slot of the longitudinal sheet;
the transversal sheets are intercepted by the longitudinal sheet;
the transversal sheets are turned over onto the longitudinal sheet so as to overlap each other;
the flattened separators are stacked.
